(19) United States
(12) Patent Application Publication
(10) Pub. No.: US 2012/0103023 A1
(43) Pub. Date: May 3, 2012

(54) METHOD OF MANUFACTURING GLASS PREFORM

(75) Inventors: Tomohiro Ishihara, Kanagawa (JP); Teruhiko Itou, Kanagawa (JP)

(73) Assignee: SUMITOMO ELECTRIC INDUSTRIES, LTD., Osaka-shi (JP)

(21) Appl. No.: 13/281,848

(22) Filed: Oct. 26, 2011

(30) Foreign Application Priority Data
Oct. 27, 2010 (JP) 2010-240901

(51) Int. Cl. C03B 37/07; C03B 37/018

(52) U.S. Cl. 65/382; 65/377

(57) ABSTRACT

According to one embodiment, there is provided a method of manufacturing a glass preform, including: obtaining a glass-fine-particle deposit by a VAD process; and heating the obtained glass-fine-particle deposit at a high temperature, thereby manufacturing a transparent glass preform, wherein, while depositing glass fine particles, in addition to monitoring a deposition shape of the glass-fine-particle deposit and controlling a pull-up rate of the glass-fine-particle deposit, there is controlled at least any of: flow rates of glass starting gases to be charged into glass-fine-particle producing burners; flow rates of flame forming gases to be charged into the glass-fine-particle producing burners; and positions of the glass-fine-particle producing burners relative to the glass-fine-particle deposit, so that the deposition shape may become a target shape, and wherein the deposition of the glass fine particles is stopped in a case where the deposition shape deviates from the target shape.

### CROSS-REFERENCE TO RELATED APPLICATION(S)

This application claims priority from Japanese Patent Application No. 2010-240901 filed on Oct. 27, 2010, the entire contents of which are incorporated herein by reference.

### FIELDS

The present invention relates to a method of manufacturing a glass preform wherein a glass fine particle deposit is manufactured by depositing glass fine particles in accordance with a VAD process.

### BACKGROUND

In a VAD process for manufacturing a glass preform for an optical fiber, glass fine particles are deposited to form glass fine particle deposit. In connection with that method, there is proposed to monitor the distal end part of the glass fine particle deposit with a CCD camera, and to control a pull-up rate, starting-gas charge quantities, or a burner position so as to make the distal end position of the deposit a predetermined position or in accordance with the change of the distal end position (refer to, for example, JP-2006-193360-A, JP-H08-198634-A, JP-2000-281378-A and JP-H08-034632-A).

There is also proposed, in manufacturing of the porous preform by a VAD process using three burners, to monitor the shape of a core portion with a CCD camera, and to control a pull-up rate, the flow rates of starting gases to be charged into the core portion, and the position of the core burner based on the change of the shape (refer to, for example, JP-H09-227147-A).

In the above mentioned method, the distal end part of the glass fine particle deposit or part of the deposition shape is monitored, and the pull-up rate and the charge quantities of the glass starting materials are controlled. However, since these methods do not intended to stabilize the shape of the whole deposit portion, the deposition shape of the glass fine particle deposit will change every manufacture of the glass preform. Thus, a core diameter, the outside diameter of a clad, and the refractive index of a core will become unstable within a lot or among lots.

### SUMMARY

One object of the present invention is to provide a method of manufacturing a glass preform in which, in manufacturing the glass preform by a VAD process, the glass preform whose clad outside diameter, whose core diameter and whose core refractive index are stable within a lot or among lots can be manufactured at a low cost.

According to an aspect of the present invention, there is provided a method of manufacturing a glass preform, including: obtaining a glass-fine-particle deposit by a VAD process; and heating the obtained glass-fine-particle deposit at a high temperature, thereby manufacturing a transparent glass preform, wherein, while depositing glass fine particles, in addition to monitoring a deposition shape of the glass-fine-particle deposit and controlling a pull-up rate of the glass-fine-particle deposit, there is controlled at least any of: flow rates of glass starting gases to be charged into glass-fine-particle producing burners; flow rates of flame forming gases to be charged into the glass-fine-particle producing burners; and positions of the glass-fine-particle producing burners relative to the glass-fine-particle deposit, so that the deposition shape may become a target shape, and wherein the deposition of the glass fine particles is stopped in a case where the deposition shape deviates from the target shape.

According to the above method, while controlling the pull-up rate of the glass-fine-particle deposit, at least any of the flow rates of the glass starting gases to be charged into the glass-fine-particle producing burner, or the flow rates of the flame forming gases, and the position of the glass-fine-particle producing burner relative to the glass-fine-particle deposit is controlled, whereby the deposition shape of the glass-fine-particle deposit can be confined within the allowable range of the target shape on and on. In this way, the deposition shape is stabilized among lots or within a lot, so that the outside diameter and density of the glass-fine-particle deposit, the concentrations of additives to be added into a core, etc. are stabilized within the lot or among the lots. Further, since the deposition shape is stabilized, the defects of the glass-fine-particle deposit, such as cracks and deformations, decrease, and the glass preform of high quality can be manufactured stably. Since the deposition of the glass fine particles is stopped in the case where the deposition shape has deviated from the target shape, the manufacturing of defective glass-fine-particle deposit can be prevented.

The target shape may be managed while setting an allowable range for a parameter, the parameter including at least any of: an outside diameter at a cylinder-shaped distal end part of the glass-fine-particle deposit; an outside diameter of a cylinder-shaped steady part of the glass-fine-particle deposit; and a taper angle of a taper shape part of the glass-fine-particle deposit. The deposition of the glass fine particles may be stopped in a case where all of the parameter deviates from the allowable range.

According to the above method, defective can be prevented from occurring, and since human operations required for the monitoring of a manufacturing state can be relieved, a manufacturing cost can be reduced.

The monitoring of the deposition shape may be performed by a CCD camera and an image processing device.

According to the above method, the configuration can be realized at a low installation cost, and the deposition shape can be identified at a high precision.

According to the above-exemplified methods, the deposition shape of the glass-fine-particle deposit is brought to the target shape by controlling at least any of the pull-up rate of the glass-fine-particle deposit, the flow rates of the glass starting gases to be charged into the glass-fine-particle producing burner or the flow rates of the flame forming gases, and the position of the glass-fine-particle producing burner relative to the glass-fine-particle deposit, so that the deposition shape is stabilized within a lot or among lots, and the outside diameter and density of the glass-fine-particle deposit, the concentrations of the additives to be added into the core, etc. are stabilized within the lot or among the lots. Since the deposition shape is stabilized, the defects of the glass-fine-particle deposit, such as cracks and deformations, decrease, and the glass preform of high quality can be manufactured stably.

### BRIEF DESCRIPTION OF THE DRAWINGS

FIG. 1 illustrates a manufacturing apparatus related to a method of manufacturing a glass preform.

FIG. 2 enlargedly illustrates the distal end part of a glass-fine-particle deposit in FIG. 1.

FIG. 3 illustrates the method of manufacturing a glass preform.

### DETAILED DESCRIPTION

A method of manufacturing a glass preform according to an embodiment will be described with reference to the drawings.

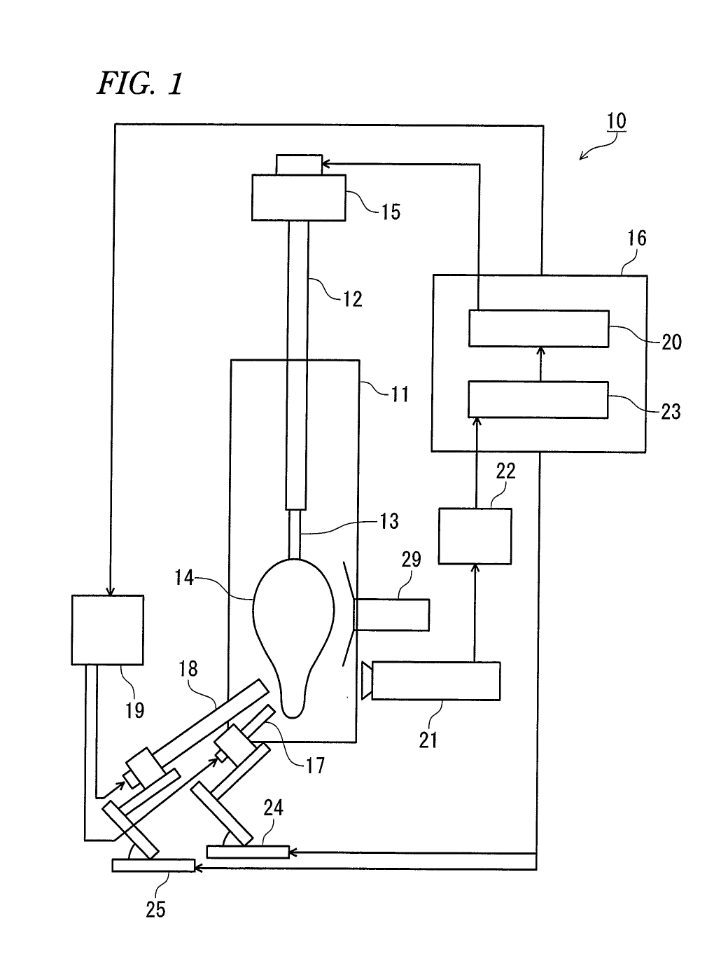

FIG. 1 illustrates a manufacturing apparatus 10 which executes the method of manufacturing a glass preform in this embodiment. In the manufacturing apparatus 10, a support bar 12 is suspended above a reaction vessel 11 toward thereinside, and a dummy glass rod 13 is attached to the lower side of the support bar 12. Glass fine particles are deposited onto the dummy glass rod 13, thereby forming a glass-fine-particle deposit 14. An elevation device 15 grasps an upper end part of the support bar 12 to rotate and move the support bar 12 up/down. This elevation device 15 is controlled by a pull-up-rate controller 20 within a control device 16.

A burner 17 for a core, and a burner 18 for a clad are disposed inside the reaction vessel 11 at the lower part thereof. Starting gases, flame forming gases (combustible gases and oxidizing gases), etc. are fed from a gas feed device 19 to the burners 17 and 18 while the control device 16 controls respective feed quantities.

The burners 17 and 18 function as glass-fine-particle producing burners to produce the glass fine particles. The burner 17 charges SiCl₄ and GeCl₄ as the starting gases, H₂ and O₂ as the flame forming gases, and N₂ as a burner seal gas. The burner 18 charges SiCl₄ as the starting gas, H₂ and O₂ as the flame forming gases, and N₂ as the burner seal gas.

A CCD camera 21 for capturing the deposited part of the glass-fine-particle deposit 14 is installed at the lower part of the manufacturing apparatus 10. The image signal of the captured deposition shape is subjected to image processing by an image processing device 22, and the image signal is thereafter sent to a deposition-shape measurement unit 23 within the control device 16. In the deposition-shape measurement unit 23, parameters related to the deposition shape are calculated. Besides, an exhaust pipe 29 is mounted on the side wall part of the reaction vessel 11.

At the lower part of the manufacturing apparatus 10, the burner 17 for the core and the burner 18 for the clad are respectively furnished with independent burner stages 24 and 25. The burner stages 24 and 25 adjust the positions of the burner 17 and the burner 18 relative to the glass-fine-particle deposit 14, respectively. More specifically, the burner stages 24 and 25 respectively adjust the angles of the corresponding burner and the positions in horizontal, vertical and depth directions of the corresponding burners, based on control signals from the control device 16.

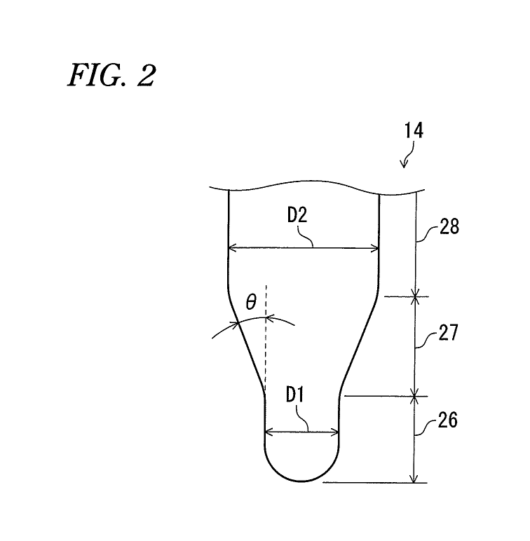

In this embodiment, as shown in FIG. 2, a first columnar shape part 26 is defined on the distal end part of the glass-fine-particle deposit 14, a second columnar shape part 28 is defined on the steady part thereof, and a taper shape part 27 is defined between the parts 26 and 28. And, the deposition shape of the glass-fine-particle deposit 14 is managed in terms of the parameters consisting of the outside diameter D1 of the first columnar shape part 26, the outside diameter D2 of the second columnar shape part 28, and the taper angle θ of the taper shape part 27.

The outside diameters D1 and D2 of the respective columnar shape parts 26 and 28 and the taper angle θ of the taper shape part 27 are monitored (calculated from the image signal of the deposition shape which has been captured by the CCD camera 21 and subjected to the image processing). Subsequently, the flow rates of the starting gases, the flow rates of the flame forming gases, and the burner positions are controlled so that the calculated outside diameters and taper angle may be respectively confined within the allowable ranges (for example, the outside diameter D1; 30-35 mm, the outside diameter D2; 150-180 mm, and the taper angle; 30-40 degrees), and so that the deposition shape may be approximated to the target shape (for example, an outside diameter DO1=32.5 mm, an outside diameter DO2=165 mm, and a taper angle θO=35 degrees as the center values of the allowable ranges).

As the manufacturing procedure of the glass-fine-particle deposit 14, first of all, the support bar 12 is connected to the elevation device 15, and the glass rod 13 attached to the distal end of the support bar 12 is accommodated within the reaction vessel 11. Subsequently, the glass fine particles are deposited onto this glass rod 13 by the burner 17 for the core and the burner 18 for the clad while rotating the glass rod 13 with the elevation device 15. While depositing the glass fine particles, the glass-fine-particle deposit 14 is pulled up by the elevation device 15.

On this occasion, the shape of the deposited part of the glass-fine-particle deposit 14 is successively monitored with the CCD camera 21 which is installed in correspondence with the lower part of the reaction vessel 11. Here, the glass-fine-particle deposit 14 is pulled up in accordance with the growth rate of the distal end part thereof. Also, the flow rates of the starting gases and flame forming gases, and the burner positions are adjusted while comparing the monitored parameters of the deposit 14 with the outside diameter DO1, outside diameter DO2 and taper angle θO of the target shape.

Subsequently, the obtained glass-fine-particle deposit 14 is turned into a transparent glass by heating it to 1100° C. in a mixed atmosphere consisting of He and Cl, and thereafter heating it to 1550° C. in a He atmosphere. Such manufacture of the glass preform is repeatedly executed.

Next, a method of manufacturing a glass preform in this embodiment will be described.

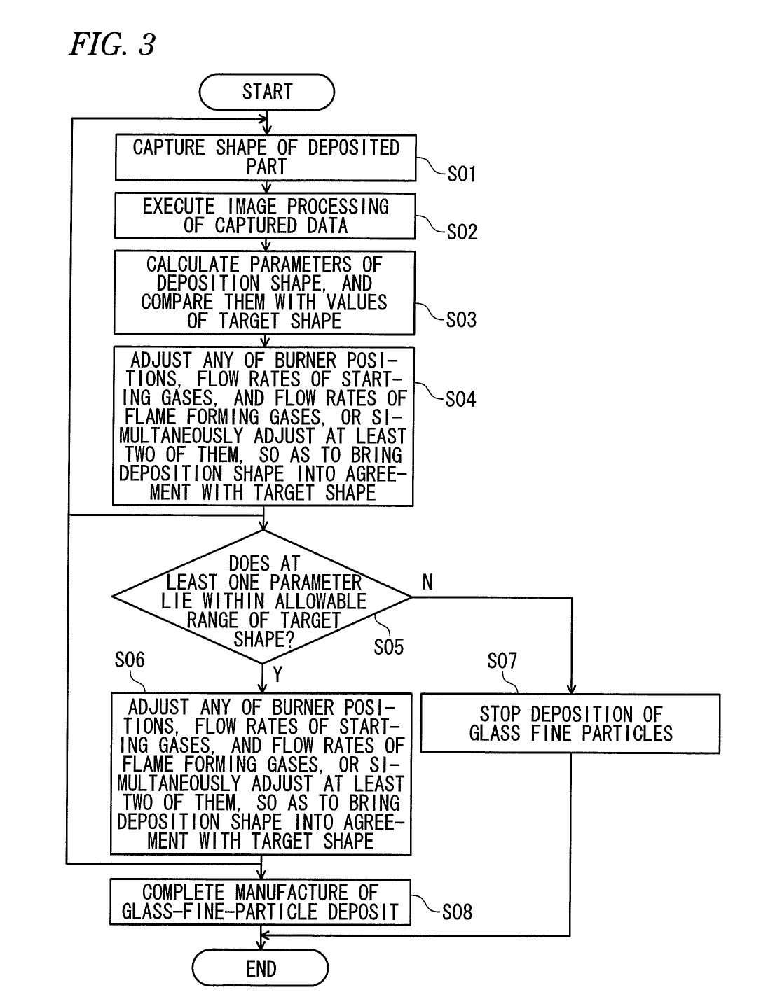

As shown in FIG. 3, in the method of manufacturing the glass preform in this embodiment, the shape of the deposited part of the glass-fine-particle deposit 14 is first captured by the CCD camera 21 (S01).

The captured image signal is subjected to the image processing by the image processing apparatus 22 (S02).

The data obtained by the image processing are sent to the deposition-shape measurement unit 23 within the control device 16 so as to calculate the parameters related to the deposition shape. And, comparisons are made between the measurement shape (the outside diameter D1, the outside diameter D2, and the taper angle θ) and the target shape (the outside diameter DO1, the outside diameter DO2, and the taper angle θO) previously stored in the control device (S03).

In accordance with the comparisons, the burner stages 24 and 25 are driven based on the control signals from the control device 16 to thereby adjust the positions of the burner 17 for the core and the burner 18 for the clad relative to the glass-fine-particle deposit 14, so as to approximate the measurement shape (D1, D2, and θ) to the target shape (DO1, DO2, and θO) (S04).

Alternatively, the flow rates of the starting gases are adjusted singly or simultaneously with the burner positions. That is, the feed flow rates of the starting gases for the burner 17 for the core and for the burner 18 for the clad are adjusted by the gas feed device 19 based on the control signals from the control device 16 (S04).

Alternatively, the flow rates of the flame forming gases are adjusted singly or simultaneously with the burner positions or/and the flow rates of the starting gases. That is, the feed flow rates of the flame forming gases for the burner 17 for the core and for the burner 18 for the clad are adjusted by the gas feed device 19 based on the control signals from the control device 16 (S04). Thereafter, the process returns to the capturing of the shape of the deposited part (S01).

At least by virtue of step S04 executed based on the control signals from the control device 16, the glass-fine-particle deposit 14 can be manufactured to be closer to the target shape.

In a case (“Y” at S05) where, after the above comparisons have been repeated plural times, at least any of the measurement shape parameters (D1, D2, and θ) lies within the allowable range of the corresponding target shape (DO1, DO2, or θO), adjustments similar to those of the step S04 are successively made (S06). Thereafter, the process returns to the capturing of the shape of the deposited part (S01). After the execution of the step S05, it is not always necessary to repeat the above comparisons plural times. The manufacture of the glass-fine-particle deposit 14 is completed (S08) by repeating such steps.

In a case (“N” at S05) where, even when the above comparisons have been repeated plural times, all the measurement shape parameters (D1, D2, and θ) deviate from the allowable ranges of the target shape (DO1, DO2, and θO), the deposition of the glass fine particles is immediately stopped (S07). Thus, the manufacturing of defective glass preform can be prevented.

According to the method of manufacturing the glass preform in this embodiment, the deposition shape of the glass-fine-particle deposit 14 is monitored during the deposition, and while controlling the pull-up rate of the glass-fine-particle deposit 14, at least any of the flow rates of the glass starting gases to be charged into the glass-fine-particle producing burners 17 and 18, the flow rates of the flame forming gases, and the positions of the glass-fine-particle producing burners 17 and 18 relative to the glass-fine-particle deposit 14 is controlled so that the deposition shape may become the target shape. Besides, in the case where all the parameters of the deposition shape deviate from the allowable ranges of the target shape, the deposition of the glass fine particles is stopped.

Thus, the deposition shape is stabilized among lots or within a lot, so that the outside diameter and density of the glass-fine-particle deposit 14, the concentrations of the additives to be added into the core, etc. are stabilized within the lot or among the lots. Moreover, since the deposition shape is stabilized, the defects of the glass-fine-particle deposit 14, such as cracks and deformations, decrease, and the glass preform of high quality can be manufactured stably.

The target shape is managed by setting the allowable range for at least any of the outside diameters D1 and D2 of the cylindrical shape parts 26 and 28 of the distal end part and steady part of the glass-fine-particle deposit 14 and the taper angle θ of the taper shape part 27, and the deposition of the glass fine particles is stopped in the case where all of the outside diameters and the taper angle deviate from the allowable ranges. Thus, defective can be prevented from occurring, and since human operations required for the monitoring of a manufacturing state can be relieved, a manufacturing cost can be reduced.

Since the monitoring of the deposition shape is performed with the CCD camera 21 and the image processing apparatus 22, the configuration can be realized at a low installation cost, and the deposition shape can be identified at a high precision.

Next, an example of the method of manufacturing the glass preform will be described. In both the example and a comparative example, the glass preforms were manufactured using materials as listed below.

Dummy glass rod; pure silica glass being 25 mm in diameter and 400 mm in length

Gases to be charged into the burner for the core; starting gases . . . SiCl₄ and GeCl₄, flame forming gases . . . H₂ and O₂, and burner seal gas . . . N₂

Gases to be charged into the burner for the clad; starting gas . . . SiCl₄, flame forming gases . . . H₂ and O₂, and burner seal gas . . . N₂

### Example

While monitoring a deposition shape with the CCD camera 21 installed in correspondence with the lower part of the reaction vessel 11, the deposition of glass fine particles was executed at a pull-up rate which corresponded to the growth rate of the distal end part (refer to FIG. 1). The outside diameters D1 and D2 of the respective cylindrical shape parts 26 and 28, and the taper angle θ of the taper shape part 27 were calculated from the captured deposition shape, and each and all of the flow rates of the starting gases, the flow rates of the flame forming gases, and the burner positions was/were controlled so that the parameters might be confined within the allowable ranges (the outside diameter D1=30-35 mm, the outside diameter D2=150-180 mm, and the taper angle θ=30-40 degrees, and refer to FIG. 2), and so that the parameters might be approached to the target shape (the outside diameter D01=32.5 mm, the outside diameter D02=165 mm, and the taper angle θ0=35 degrees). In the case where all the parameters of the deposition shape deviated from the allowable ranges, the deposition of the glass fine particles was stopped. The obtained glass-fine-particle deposit was turned into the transparent glass by heating it to 1100° C. in the mixed atmosphere consisting of He and Cl, and thereafter heating it to 1550° C. in the He atmosphere, whereby the glass preform was fabricated.

### Comparative Example

The deposition shape of the distal end part of a glass-fine-particle deposit was monitored by a CCD camera, and a pull-up rate was controlled in correspondence with the growth rate of the distal end part. On this occasion, the deposition shape of the glass-fine-particle deposit was sometimes deformed due to the structures of burners, but the manufacture of the glass-fine-particle deposit was continued in the deformed state. The obtained glass-fine-particle deposit was turned into transparent glass under the same conditions as in the example.

In both the example and the comparative example, the manufactures of the glass preforms were repeated by the above methods, and the fluctuation (dispersion: σ) of the difference (Δn) between the specific refractive indexes of the core portion and clad portion of each glass preform, and the fluctuation (dispersion: σ) of the ratio D/d between a core diameter (d) and the clad outside diameter (D) were compared as to N=10 (ten rods).

TABLE 1

| | Control items | | | | |
|---|---|---|---|---|---|
| | Example | | | | |
| | | | Flame | | Compar- |
| | Burner | Starting | forming | | ative |
| Evaluation | positions | gases | gases | All of | example |
| items | \textcircled{1} | \textcircled{2} | \textcircled{3} | \textcircled{1}-\textcircled{3} | No control |
| Δn fluctu- | 0.002 | 0.003 | 0.004 | 0.001 | 0.009 |
| ation (%) | | | | | |
| D/d | 0.02 | 0.03 | 0.04 | 0.01 | 0.06 |
| fluctuation | | | | | |

As a result, values as indicated in Table 1 were obtained.

In the case where, as in the example, the burner positions, the flow rates of the starting gases, or/and the flow rates of the flame forming gases were controlled so as to make the deposition shape the target shape, both the Δ fluctuations and the D/d fluctuations became smaller than in the comparative example in which no control was performed. It was also conformed that, in the case where all of the burner positions, the flow rates of the starting gases, and the flow rates of the flame forming gases were adjusted, the fluctuations became the smallest. In the example, the deposition of the glass fine particles was stopped in the case where all the parameters of the deposition shape deviated from the allowable ranges, so that the number of defective glass preforms became zero.

On the other hand, in the comparative example, among the manufactured glass preforms of N=10 (ten glass preforms), five ones underwent large D/d fluctuations due to deformations and became defective glass preforms. The remaining five glass preforms underwent the Δn fluctuations of σ=0.009% and the D/d fluctuations of σ=0.06%, and these fluctuations were larger than in the example. Besides, the manufacturing cost of the comparative example became about double as high as that of the example.

The method of manufacturing an optical fiber preform in the present invention is not restricted to the embodiment, but it can be appropriately subjected to modifications, improvements, etc. The materials, shapes, dimensions, numerical values, forms, numbers, arrangement places, etc. of the individual constituents in the embodiment are optional as long as the present invention can be achieved, and they are not especially restricted.

1. A method of manufacturing a glass preform, comprising:
obtaining a glass-fine-particle deposit by a VAD process; and
heating the obtained glass-fine-particle deposit at a high temperature, thereby manufacturing a transparent glass preform,
wherein, while depositing glass fine particles, in addition to monitoring a deposition shape of the glass-fine-particle deposit and controlling a pull-up rate of the glass-fine-particle deposit, there is controlled at least any of:
flow rates of glass starting gases to be charged into glass-fine-particle producing burners;
flow rates of flame forming gases to be charged into the glass-fine-particle producing burners; and
positions of the glass-fine-particle producing burners relative to the glass-fine-particle deposit, so that the deposition shape may become a target shape, and
wherein the deposition of the glass fine particles is stopped in a case where the deposition shape deviates from the target shape.

2. The method of claim 1,
wherein the target shape is managed while setting an allowable range for a parameter, the parameter comprising at least any of:
an outside diameter at a cylinder-shaped distal end part of the glass-fine-particle deposit;
an outside diameter of a cylinder-shaped steady part of the glass-fine-particle deposit; and
a taper angle of a taper shape part of the glass-fine-particle deposit, and
wherein the deposition of the glass fine particles is stopped in a case where all of the parameter deviates from the allowable range.

3. The method of claim 1,
wherein the monitoring of the deposition shape is performed by a CCD camera and an image processing device.
